(19) United States
(12) Patent Application Publication
(10) Pub. No.: US 2016/0293960 A1
(43) Pub. Date: Oct. 6, 2016

(54) CATHODE OF ALL-SOLID STATE LITHIUM-SULFUR SECONDARY BATTERY USING GRAPHENE OXIDE AND METHOD FOR MANUFACTURING THE SAME

(71) Applicant: Hyundai Motor Company, Seoul (KR)

(72) Inventor: Yong Gu Kim, Suwon (KR)

(21) Appl. No.: 14/960,793

(22) Filed: Dec. 7, 2015

(30) Foreign Application Priority Data
Apr. 2, 2015 (KR) 10-2015-0046953

(51) Int. Cl. H01M 4/62; H01M 4/136; H01M 4/1393; H01M 10/052; H01M 4/38; H01M 4/58; H01M 4/587; H01M 4/04; H01M 4/133; H01M 4/1397

(52) U.S. Cl. CPC H01M 4/625; H01M 4/133; H01M 4/136; H01M 4/1393; H01M 4/1397; H01M 4/382; H01M 4/5815; H01M 4/38; H01M 4/587; H01M 4/622; H01M 4/0404; H01M 10/052; H01M 2004/028

(57) ABSTRACT

Disclosed is a cathode of an all-solid state lithium-sulfur secondary battery, and a method for manufacturing the same. In particular, the cathode of the all-solid state lithium-sulfur secondary battery may comprise a graphene oxide connecting active material-carbon material complexes to improve electron transporting efficiency in the cathode, such that a battery capacity is improved.

### CROSS-REFERENCE TO RELATED APPLICATION

This application claims under 35 U.S.C. §119(a) the benefit of Korean Patent Application No. 10-2015-0046953 filed on Ap. 2, 2015, the entire contents of which are incorporated herein by reference.

### TECHNICAL FIELD

The present invention relates to a cathode of an all-solid state lithium-sulfur secondary battery using a graphene oxide, and a method for manufacturing the same. The cathode of an all-solid state lithium-sulfur secondary battery may comprise a graphene oxide which may connect active material-carbon material complexes, such that electron transporting efficiency may be improved in the cathode.

### BACKGROUND

A secondary battery that can be charged and discharged has been extensively used as a large-capacity electric power storage battery in an electric vehicle, an electric power storage system, and the like, or as a small-sized high performance energy source of a mobile electronic apparatus such as a mobile phone, a camcorder, and a notebook computer.

A lithium ion battery as the secondary battery provides merits, e.g. high energy density, and high capacity per unit area as compared to a nickel-manganese battery or a nickel-cadmium battery.

However, the lithium ion battery has various problems to be used for a next-generation electric vehicle, such as a problem in safety due to overheating, a low energy density of about 360 Wh/kg, and a low output.

In order to overcome those problems of the lithium ion battery, research and development of a lithium-sulfur secondary battery that can implement a high output and high energy density have been actively performed.

The lithium-sulfur secondary battery is a battery using sulfur as a cathode active material and a lithium metal as an anode, and since theoretical energy density can reach to 2500 Wh/kg, the lithium-sulfur secondary battery is suitable as a battery for an electric vehicle requiring a high output and high energy density.

Generally, the lithium-sulfur secondary battery has been manufactured using a liquid electrolyte. However, a portion of a lithium-sulfur compound is dissolved in the liquid electrolyte thereby reducing a life-span property. In addition, a dangerousness problem such as liquid leakage of the liquid electrolyte and fire at high temperatures, and the like may occur.

In order to solve the aforementioned problems, an interest in all-solid state lithium-sulfur secondary battery where the liquid electrolyte is replaced by a solid electrolyte has been increased, but the all-solid state lithium-sulfur secondary battery may have problems such as low capacity and short life-span properties due to reduction in mobility of ions and electronic conductivity.

In a certain example, to improve a capacity of the lithium-sulfur secondary battery, Korean Patent Application Laid-Open No. 10-2014-0086811, discloses a lithium-sulfur secondary battery by using a porous material as a conductive material added to a cathode of the lithium-sulfur secondary battery to implement greater amount of sulfur than the related art. However, when the conductive material of a porous material (hereinafter, referred to as “porous conductive material”) is used, sulfur can be injected into a blow hole of the porous conductive material to form a kind of bundle type structure, and electrons are not easily transported between the complexes. Accordingly, sufficient improvement of capacity may not be obtained.

The above information disclosed in this Background section is only for enhancement of understanding of the background of the invention and therefore it may contain information that does not form the prior art that is already known in this country to a person of ordinary skill in the art.

### SUMMARY OF THE INVENTION

In preferred aspects, the present invention provides a cathode of an all-solid state lithium-sulfur secondary battery using a graphene oxide. The cathode may comprise a conductive material which comprises a porous carbon material and the graphene oxide such that electrons may be sufficiently transported between active material-carbon material complexes that are formed by injecting a cathode active material into the porous carbon material.

The object of the present invention is not limited to the aforementioned matter, and unmentioned other objects may be clearly understood by the person with ordinary skill in the art from the following description.

The present invention may include the following constitution in order to accomplish the aforementioned object.

In one aspect, the present invention provides a cathode of an all-solid state lithium-sulfur secondary battery. The cathode may comprise: an cathode active material; a conductive material comprising a porous carbon material and the graphene oxide; a solid electrolyte; and a binder.

The term “porous carbon”, as used herein, refers a carbon-based material or carbon material with pores, for example, to provide high surface area and physicochemical properties and carbon walls maintain those pores. The size of the pores and pore structures may vary depending on method for synthesis thereof. For example, the porous carbons may be microporous or mesoporous carbons based on average size of the pores, and those pores may be either ordered or disordered. Further, the porous carbon may be formed in particles having an average size ranging from about 0.1 μm to about 10 μm, however, suitable porous carbons may not be limited to thereto. Preferably, the cathode active material may be included in an amount of about 10 to 70 wt %, the conductive material may be included in an amount of about 1 to 30 wt %, the solid electrolyte may be included in an amount of about 10 to 70 wt %, and the binder may be included in an amount of about 1 to 10 wt %, all the wt % are based on the total weight of the cathode.

Further, the cathode may consist, consist essentially of, or essentially consist of the components of the cathode as described herein. For example, the cathode may consist, consist essentially of, or essentially consist of: the cathode active material in an amount of about 10 to 70 wt %, the conductive material in an amount of about 1 to 30 wt %, the solid electrolyte in an amount of about 10 to 70 wt %, and the binder in an amount of about 1 to 10 wt %, all the wt % based on the total weight of the cathode.

Preferably, the porous carbon material and the graphene oxide may be mixed at a ratio of about 1:9 to about 9:1.

In particular, the cathode active material may form an active material-carbon material complex together with the porous carbon material, and the graphene oxide may connect the active material-carbon material complex to another adjacent active material-carbon material complex to improve electron transporting efficiency in the cathode.

Preferably, the graphene oxide may include a functional group reacting with the cathode active material, and the functional group may be one or more reaction groups selected from a hydroxyl group, a carboxyl group, and ether.

Preferably, the porous carbon material may be a mesoporous carbon.

The term “mesoporous carbon”, as used herein, refers a carbon-based material or carbon material having a plurality of pores having a size (diameter) less than about 500 nm, less than about 400 nm, less than about 300 nm, less than about 200 nm, less than about 100 nm, or less than about 50 nm, or particularly having a size of about 1 nm to 50 nm. In the mesoporous carbon, thus pores may be arranged regularly or irregularly based on the density, porosity, permeability and the like thereof, but those arrangements of the pores in the mesoporous carbon of the present invention may not be particularly limited.

Thus, alternatively, the porous carbon material may comprise ordered pores having a size from about 1 nm to about 500 nm.

Preferably, the solid electrolyte may be a sulfide-based solid electrolyte or an oxide-based solid electrolyte, and the cathode active material may be sulfur or lithium sulfide (Li₂S).

Preferably, a thickness of the cathode may be of about 100 to 500 μm.

In another aspect, the present invention provides a method for manufacturing a cathode of an all-solid state lithium-sulfur secondary battery, and the method may comprise: preparing a slurry by mixing an amount of about 10 to 70 wt % of a cathode active material, an amount of about 1 to 30 wt % of a conductive material comprising a porous carbon material and a graphene oxide, an amount of about 10 to 70 wt % of a solid electrolyte, and an amount of about 1 to 10 wt % of a binder, all the wt % based on the total weight of the slurry; applying the slurry on a cathode substrate; and drying the slurry applied on the cathode substrate.

Further provided are all-solid state lithium-sulfur secondary batteries that may comprise: a cathode as described herein, an anode comprising a lithium metal, and a solid electrolyte layer interposed between the cathode and the anode.

The present invention also provides vehicles that comprise the all-solid state lithium-sulfur secondary battery as described herein.

The present invention may have the following effects by including the aforementioned constitution.

The cathode of an all-solid state lithium-sulfur secondary battery of the present invention may provide an effect that a cathode active material may be uniformly distributed over a wide surface area in the cathode by the graphene oxide, and thus an initial capacity may be improved.

Further, since the graphene oxide interacts with the cathode active material to prevent the cathode active material from leaving surroundings of a conductive material during charging and discharging, a life-span property may be improved.

In addition, the life-span property may be improved, and simultaneously a use amount of a binder may be reduced by the graphene oxide which connects the cathode active material and the porous carbon material so as to maintain a structure of an active material-carbon material complex.

The cathode of the all-solid state lithium-sulfur secondary battery using the graphene oxide of the present invention may also provide an effect that the cathode contains greater cathode active material content by the porous carbon material and electrons are easily transported between the active material-carbon material complexes by the graphene oxide, and thus the capacity of the battery may be substantially improved.

Other aspects and preferred embodiments of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 illustrates a mechanism during discharging of a lithium-sulfur secondary battery;

FIG. 2 illustrates a cathode active material and a conductive material of a conventional all-solid state lithium-sulfur secondary battery;

FIG. 3 illustrates an exemplary cathode active material and an exemplary conductive material of an exemplary all-solid state lithium-sulfur secondary battery according to an exemplary embodiment of the present invention;

FIG. 4 is a graph obtained by measuring a capacity of an exemplary all-solid state lithium-sulfur secondary battery manufactured in an Example according to an exemplary embodiment of the present invention; and

FIG. 5 is a graph obtained by measuring a capacity of a conventional all-solid state lithium-sulfur secondary battery manufactured in a Comparative Example.

Reference numerals set forth in the Drawings include reference to the following elements as further discussed below:

10: Cathode active material

21: Porous carbon material

23: Graphene oxide

30: Active material-carbon material complex

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The terminology used herein is for the purpose of describing particular exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Hereinafter reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

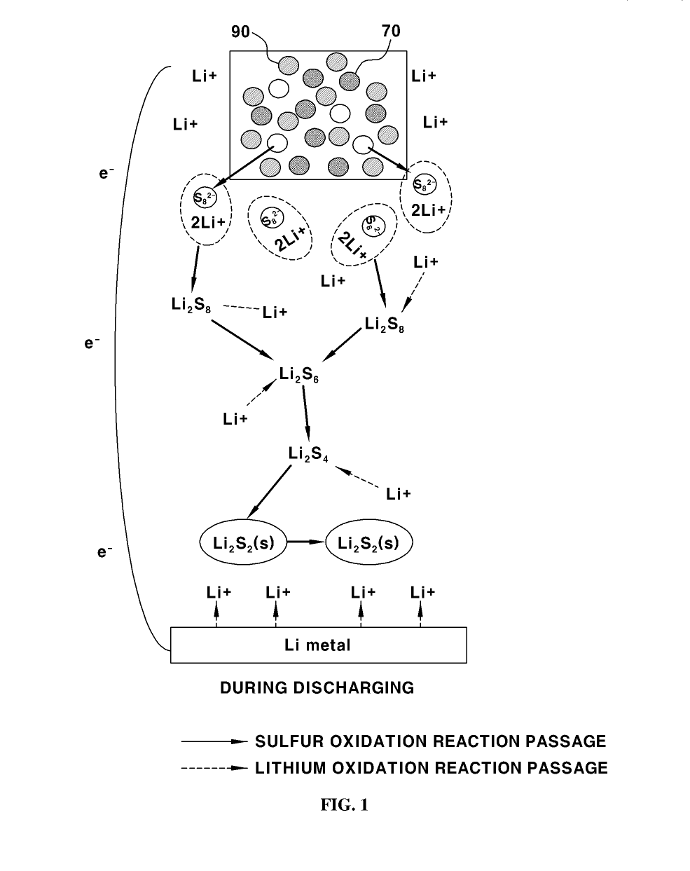

FIG. 1 illustrates a mechanism during discharging of a lithium-sulfur secondary battery. Theoretically, during discharging, an electron transported from a lithium cathode (Li metal) is bonded to sulfur (a cathode active material) 70 adjacent to a surface of a conductive material 90 and thus, reduced S₈²⁻ can be formed.

Subsequently, S₈²⁻ are bonded to a lithium ion to form Li₂S₈ (long-chain polysulfide), and Li₂S₈ is finally precipitated in a form of Li₂S₂/Li₂S (short-chain polysulfide) on a surface of the lithium cathode due to a continuous reduction reaction with the lithium ion.

During charging, an oxidation reaction occurs to allow Li₂S₈ to be returned back to S₈²⁻ through a reverse process, and the electron is lost on the surface of the conductive material 90 to precipitate sulfur 70 again.

As described above, since the electron generated by a reaction between the sulfur (cathode active material) and lithium is continuously transported in the battery to charge and discharge the battery, efficient transportation of the electron in the battery, particularly in the cathode directly relates to the capacity of the battery and is very important.

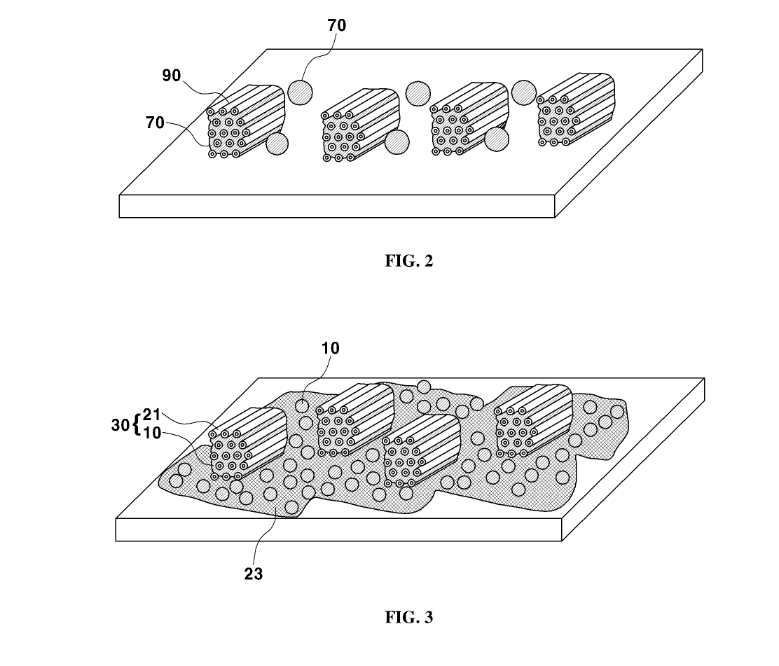

In the related art, as illustrated in FIG. 2, in order to improve the capacity of the battery, the porous conductive material 90 has been used. For instance, since the cathode active material 70 is injected into the blow hole of the porous conductive material 90, the high content of the cathode active material 70 may be implemented.

However, since the cathode active material 70 and the porous conductive material 90 form bundled structure and connection between the bundles is not well performed, the electron may not be transported sufficiently, and thus the improved capacity of the battery does not reach an expected value.

Accordingly, the present invention, as illustrated in FIG. 3, provides the all-solid state lithium-sulfur secondary battery having improved electron transporting efficiency in the cathode by adding a graphene oxide (e.g. planar graphene oxide) as an auxiliary conductive material to the cathode. As such, a connection passage may be formed between the active material-carbon material complexes which may be formed by injecting the cathode active material into the porous carbon material.

The cathode of the all-solid state lithium-sulfur secondary battery using the graphene oxide according to the present invention (hereinafter, referred to as ‘cathode’) may include the cathode active material, the conductive material, the solid electrolyte, and the binder.

As the cathode active material, the solid electrolyte, and the binder, typically used materials for the cathode in the related arts may be used without limitation. For instance, preferably, sulfur or lithium sulfide (Li₂S) may be used as the cathode active material, a sulfide-based or oxide-based solid electrolyte may be used as the solid electrolyte, and a fluorine-based, rubber-based, or acrylate-based binder may be used as the binder.

Since the cathode active material, the solid electrolyte, and the binder perform generally known functions in the cathode, a detailed content thereof will be omitted.

As shown in FIG. 3, the porous carbon material and the graphene oxide may be mixed and used as the conductive material.

For instance, the cathode active material may be injected into the blow hole formed in the porous carbon material to form the active material-carbon material complex (hereinafter, also referred to as ‘complex’). Unlike the conventional conductive material, since the carbon material is porous or mesoporous, greater amount of the cathode active material may be implemented than the conventional conductive material.

As the porous carbon material, any conductive material having a porous property may be used without limitation, but preferably, a mesoporous carbon or ordered mesoporous carbon may be used.

In particular, the graphene oxide may connect the complex to another adjacent complex and thus may sufficiently transport the electron between the complexes.

The graphene oxide does not have a predetermined shape, but preferably, the graphene oxide having a planar or sheet-like shape may be suitably used to reduce resistance to transportation of the electron in the cathode and minimize an influence on a thickness of the cathode.

Since the graphene oxide improves electron transporting efficiency, during charging and discharging of exemplary all-solid state lithium-sulfur secondary batteries, the electrons may be efficiently transported from a complex to another complex, and thus the electron may be actively transported in the electrode to improve the capacity of the battery.

Preferably, the graphene oxide may include chemical or functional groups that may interact with the cathode active material including sulfur. Exemplary functional groups of the graphene oxide may be a hydroxyl group, a carboxyl group, and ether. In certain examples, the functional group may exist at a surface of the graphene oxide.

Therefore, the cathode active material may be attached to, as illustrated in FIG. 3, the surface of the graphene oxide as well as the blow hole of the porous carbon material. Accordingly, the cathode active material may be uniformly distributed in the cathode to increase a surface area and resultantly improve the capacity of the battery.

As described above, the cathode active material is reduced to S₈²⁻ during discharging of the battery and is precipitated into sulfur during charging. In this case, when precipitated sulfur is not fixed, the life-span of the battery may be reduced due to a loss of the cathode active material.

Since the graphene oxide may interact with the cathode active material through functional groups at the surface thereof, the occurrence of the aforementioned problem may be prevented by fixing the cathode active material precipitated during charging of the battery in the cathode.

Since the graphene oxide also serves to connect the complex to another adjacent complex and bind the cathode active material and the porous carbon material in the complex with each other, the cathode according to the present invention may reduce the content of the binder.

Further, since the porous carbon material and the graphene oxide are used together, the capacity of the all-solid state lithium-sulfur secondary battery may be synergistically improved.

When the cathode includes only the porous carbon material, the content of the cathode active material may be increased, but since the complexes may not be suitably connected to each other, the capacity of the battery may not be improved sufficiently.

Further, when the cathode includes only the graphene oxide, the surface area of the cathode active material may be increased and the electron may be sufficiently transported in the cathode. However, the content of the cathode active material may not be increased sufficiently, such that the capacity of the battery may not be sufficiently improved.

However, like the present invention, when the porous carbon material and the graphene oxide are mixed in the conductive material, the porous carbon material and the graphene oxide mutually may supplement drawbacks thereof, and thus, the capacity of the battery may be maximally improved.

The cathode according to the present invention may include an amount of about 10 to 70 wt % of the cathode active material, an amount of about 1 to 30 wt % of the conductive material, an amount of about 10 to 70 wt % of the solid electrolyte, and an amount of about 1 to 10 wt % of the binder, based on the total weight of the cathode. As the conductive material, preferably, the porous carbon material and the graphene oxide may be mixed at a ratio of about 1:9 to 9:1.

Thus, only when each constituent element of the cathode is included within the aforementioned numerical value range, the content of the cathode active material may be increased and the electron may be sufficiently transported to maximally improve the battery capacity of the all-solid state lithium-sulfur secondary battery.

### EXAMPLES

The following examples illustrate the invention and are not intended to limit the same. Hereinafter, the present invention will be described in more detail through the Examples. However, the Examples are set forth to illustrate the present invention, but the scope of the present invention is not limited thereto.

### Example

### (1) Manufacturing of Cathode

1) The cathode active material, the mesoporous carbon as the porous carbon material, and the graphene oxide were ground, and then heat-treated at a temperature of 160° C. for 10 hours.

2) The solid electrolyte was added to the heat-treated resulting material, followed by milling for 10 hours.

3) The binder and the solvent were added to the milled resulting material, milled for 3 hours, and mixed to manufacture the cathode slurry.

4) The cathode slurry was applied in a thickness of 100 to 500 tm on the aluminum base material by the doctor blade method.

5) The applied cathode slurry was dried at room temperature for 2 hours, and then dried in the oven at a temperature of 80° C. for 4 hours to manufacture the cathode.

In this case, the cathode included 50 wt % of the cathode active material, 10 wt % of the conductive material, 37 wt % of the solid electrolyte, and 3 wt % of the binder, based on the total weight of the cathode. The mesoporous carbon as the conductive material and the graphene oxide were mixed at the ratio of 5:5.

The cathode may be manufactured in the thickness of 100 to 500 tm so as to be applied to, for example, the button cell or the large-area cell.

The method of manufacturing the cathode, in step 1), may further include a process of performing pressing such that the cathode active material may uniformly injected into the blow hole of the porous carbon material.

### (2) Manufacturing of Battery Cell

The solid electrolyte layer was positioned on the upper side of the cathode and then pressed, and the lithium metal anode was positioned on the upper side of the solid electrolyte layer and then pressed together to manufacture the all-solid state lithium-sulfur secondary battery in the cell form.

In this case, the solid electrolyte layer may be manufactured by the wet process, and in this case, the solid electrolyte slurry may be applied on the upper side of the cathode and then dried to manufacture the solid electrolyte layer.

### Comparative Example

The all-solid state lithium-sulfur secondary battery was manufactured by the same method as the aforementioned Example, except that only the mesoporous carbon as the conductive material was used without the graphene oxide as compared to the aforementioned Example.

### Test Example

### Measurement of Capacity of Battery

Capacities during primary discharging and secondary discharging of the all-solid state lithium-sulfur secondary batteries manufactured by the Example and the Comparative Example were measured.

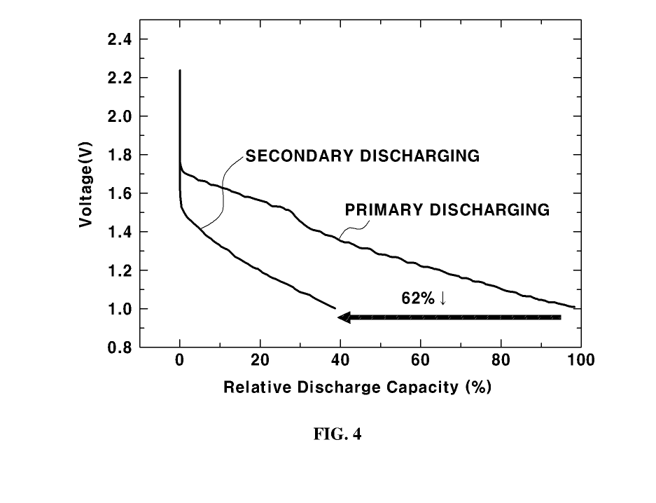

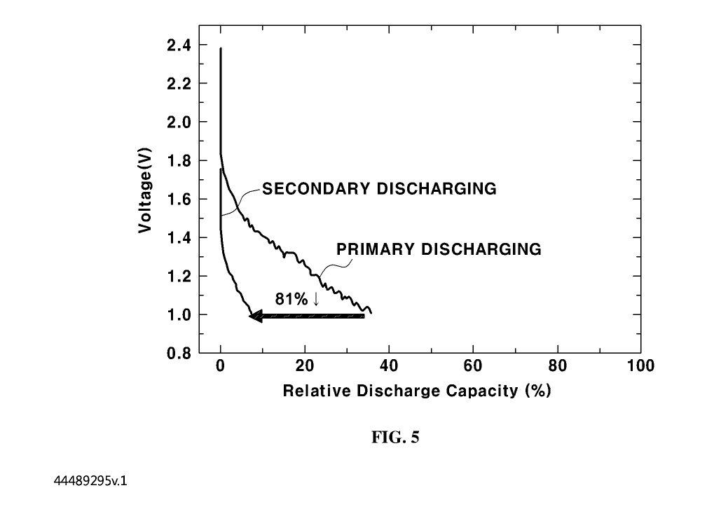

FIG. 4 shows results of measuring the capacity of the all-solid state lithium-sulfur secondary battery manufactured by the Example, and FIG. 5 shows results of measuring the capacity of the all-solid state lithium-sulfur secondary battery manufactured according to the Comparative Example.

As shown in FIGS. 4 and 5, it can be confirmed that the initial discharge capacity of the all-solid state lithium-sulfur secondary battery manufactured by the Example is substantially improved compared to that of the Comparative Example. Through this, it can be seen that the graphene oxide may connect the complexes to each other to improve transportation of the electron. Simultaneously, the functional group on the surface of the graphene oxide may interact with the cathode active material to widely distribute the cathode active material in the cathode and thus the surface area may be increased.

It can be confirmed that the capacity reduction ratio in secondary discharging after primary discharging of the all-solid state lithium-sulfur secondary battery manufactured by the Example is 62% which is less than that of the Comparative Example where the capacity reduction ratio is 81%. As such, the graphene oxide may interact with the cathode active material reduced and precipitated during charging and discharging to thereby prevent a loss from the cathode.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A cathode of an all-solid state lithium-sulfur secondary battery , comprising:
a cathode active material;
a conductive material comprising a porous carbon material and a graphene oxide;
a solid electrolyte; and
a binder.

2. The cathode of claim 1, wherein the cathode comprises the cathode active material in an amount of about 10 to 70 wt %, the conductive material in an amount of about 1 to 30 wt %, the solid electrolyte in an amount of about 10 to 70 wt %, and the binder in an amount of about 1 to 10 wt %, all the wt % based on the total weight of the cathode.

3. The cathode of claim 1, wherein the porous carbon material and the graphene oxide are mixed at a ratio of about 1:9 to about 9:1.

4. The cathode of claim 1, wherein the cathode active material forms an active material-carbon material complex together with the porous carbon material, and the graphene oxide connects the active material-carbon material complex to another adjacent active material-carbon material complex to improve electron transporting efficiency in the cathode.

5. The cathode of claim 1, wherein the graphene oxide comprises a functional group reacting with the cathode active material, and the functional group is one or more reaction groups selected from a hydroxyl group, a carboxyl group, and ether.

6. The cathode of claim 1, wherein the porous carbon material is a mesoporous carbon.

7. The cathode of claim 1, wherein the porous carbon material comprises ordered pores having a size from about 1 nm to about 20 nm.

8. The cathode of claim 1, wherein the solid electrolyte is a sulfide-based solid electrolyte or an oxide-based solid electrolyte.

9. The cathode of claim 1, wherein the cathode active material is sulfur or lithium sulfide (Li₂S).

10. The cathode of claim 1, wherein a thickness of the cathode is from about 100 to about 500 μm.

11. The cathode of claim 1, wherein the cathode consists essentially of the cathode active material in an amount of about 10 to 70 wt %, the conductive material in an amount of about 1 to 30 wt %, the solid electrolyte in an amount of about 10 to 70 wt %, and the binder in an amount of about 1 to 10 wt %, all the wt % based on the total weight of the cathode.

12. A method for manufacturing a cathode of an all-solid state lithium-sulfur secondary battery, comprising:
preparing a slurry by mixing an amount of about 10 to 70 wt % of a cathode active material, an amount of about 1 to 30 wt % of a conductive material comprising a porous carbon material and a graphene oxide, an amount of about 10 to 70 wt % of a solid electrolyte, and an amount of about 1 to 10 wt % of a binder, all the wt % based on the total weight of the slurry;
applying the slurry on a cathode substrate; and
drying the slurry applied on the cathode substrate.

13. An all-solid state lithium-sulfur secondary battery comprising:
a cathode of claim 1,
an anode comprising a lithium metal, and
a solid electrolyte layer interposed between the cathode and the anode.

14. A vehicle comprising an all-solid state lithium-sulfur secondary battery of claim 13.
